(19) United States
(12) Patent Application Publication
(10) Pub. No.: US 2014/0129699 A1
(43) Pub. Date: May 8, 2014

(54) SYSTEM AND METHOD FOR MAINTAINING DOMAIN NAME SERVICE

(71) Applicants: Mark E. Jeftovic, Etobicoke (CA); Bradley C. Cutler, Kitchener (CA); Arnon E. Clark, Toronto (CA)

(72) Inventors: Mark E. Jeftovic, Etobicoke (CA); Bradley C. Cutler, Kitchener (CA); Arnon E. Clark, Toronto (CA)

(21) Appl. No.: 13/669,941

(22) Filed: Nov. 6, 2012

(51) Int. Cl. G06F 15/173

(52) U.S. Cl. 709/224

(57) ABSTRACT

A method and system are provided for maintaining domain name service for a domain name. The domain name is associated with current resource record data and a name server delegation. The method and system involves providing at least two name server groups, which includes an active name server group and at least one spare name server group that is available to replace the active name server group; associating the active name server group to the name server delegation; receiving name server operation data corresponding to each of the at least two name server groups; and determining an operation condition indicating degraded performance within the at least two name server groups. The operation condition is determined based on the received name server operation data.

### FIELD

The described embodiments relate to systems and methods for maintaining domain name service for a domain name.

### BACKGROUND

Domain name service is a mechanism for translating between domain names and Internet Protocol (IP) addresses. Domain names can also be referred to as web addresses. Each domain name is associated with current resource record data and served by authoritative name servers. The authoritative name servers respond to queries received from other name servers or domain name resolvers within a Domain Name System. A domain name resolver is generally a type of name server that looks up domain name queries on behalf of a client, a device or an application.

The name servers execute queries for determining the IP address corresponding to a domain name. Any internet activity, such as accessing a webpage or sending an electronic message, requires one or more queries to be successfully executed by the name servers. These queries can be referred to as “domain name service lookups” or “domain name service resolutions” for the domain name.

However, name servers can be vulnerable to various failures and impairments, such as, for example, denial-of-service (DoS) attacks. Generally, DoS attacks cause a machine or network resource, such as name servers, to become unavailable to its intended users. DoS attacks may cause the name server to be unable to respond to queries. As a result, the domain name associated with that name server would not be accessible and would effectively disappear from the internet.

### SUMMARY

In accordance with an embodiment of the invention, there is provided a method for maintaining domain name service for a domain name. The domain name is associated with current resource record data and a name server delegation. The method comprises providing at least two name server groups, the at least two name server groups comprising an active name server group and at least one spare name server group, the at least one spare name server group being available to replace the active name server group; associating the active name server group to the name server delegation; receiving name server operation data corresponding to each of the at least two name server groups; and determining an operation condition indicating degraded performance within the at least two name server groups, the operation condition being determined based on the received name server operation data.

In accordance with an embodiment of the invention, there is provided a system for maintaining domain name service for a domain name. The domain name is associated with current resource record data and a name server delegation. The system comprising a control processor configured to: provide at least two name server groups, the at least two name server groups comprising an active name server group and at least one spare name server group, the at least one spare name server group being available to replace the active name server group; associate the active name server group to the name server delegation; receive name server operation data corresponding to each of the at least two name server groups; and determine an operation condition indicating degraded performance within the at least two name server groups, the operation condition being determined based on the received name server operation data.

In accordance with an embodiment of the invention, there is provided a non-transitory computer-readable medium comprising instructions executable on a control processor for implementing a method for maintaining domain name service for a domain name. The domain name is associated with current resource record data and a name server delegation. The method comprises providing at least two name server groups, the at least two name server groups comprising an active name server group and at least one spare name server group, the at least one spare name server group being available to replace the active name server group; associating the active name server group to the name server delegation; receiving name server operation data corresponding to each of the at least two name server groups; and determining an operation condition indicating degraded performance within the at least two name server groups, the operation condition being determined based on the received name server operation data.

### BRIEF DESCRIPTION OF THE DRAWINGS

A preferred embodiment of the present invention will now be described in detail with reference to the drawings, in which:

FIG. 1 is a block diagram of components interacting with a controller in accordance with an example embodiment;

FIG. 2 is a flowchart diagram illustrating the steps of maintaining a domain name service for a domain name in accordance with an example embodiment;

FIG. 3 is a flowchart diagram illustrating the steps of selecting an optimal name server group in accordance with an example embodiment;

FIGS. 4A to 4D are screenshots of an example list of name servers for a domain name in accordance with an example embodiment; and

FIG. 5 is a state diagram illustrated different operation conditions of a name server group in accordance with an example embodiment.

### DESCRIPTION OF EXEMPLARY EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein. Where considered appropriate, for simplicity and clarity of illustration, reference numerals may be repeated among the figures to indicate corresponding or analogous elements or steps.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, a suitable programmable computer may be a server, network appliance, embedded device, computer expansion module, personal computer, laptop, or any other computing device capable of being configured to carry out the methods described herein. The programmable computer may be a name server or domain name resolver, for example. Program code may be applied to input data to perform the functions described herein and to generate output information. The output information is applied to one or more output modules, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g. ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

The various embodiments described herein generally relate to methods (and associated systems configured to implement the methods) for maintaining domain name service for a domain name by facilitating substantially continuous and available domain name service resolutions for a domain name. Each domain name is associated with an authoritative name server group, which can also be referred to as an active name server group. The active name server group responds to queries received from name servers within a domain name system. The queries are generally requests for the resource record data, such as IP address records, for the domain and sub-domains of that domain. In order to substantially reduce domain name outages caused by performance problems within the active name server group, one or more spare name server groups may be provided.

One or more spare name server groups may be available to replace the active name server group. That is, the spare name server groups may act as “back-up” name server groups to the active name server group. The name servers in both the active name server group and the spare name server groups may be monitored to determine an operation condition, or status. Based on operation data corresponding to the active name server group and the spare name server groups, the system described herein may determine if any of the active name server group and the spare name server groups may be experiencing degraded performance that may affect the domain name service for the domain name.

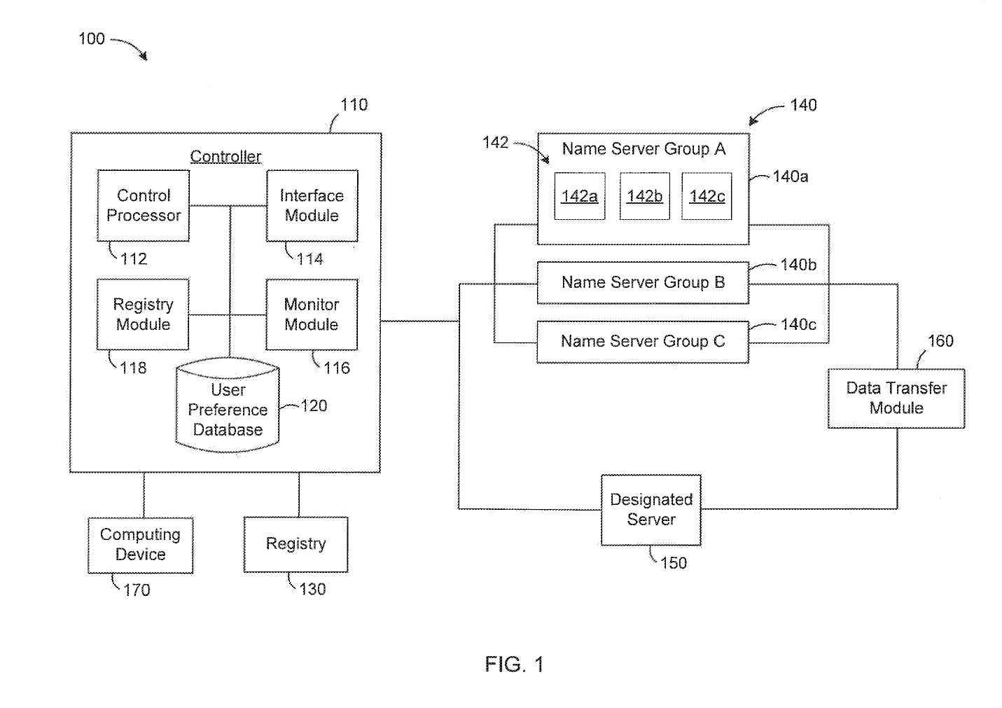

Reference is first made to FIG. 1, which illustrates a block diagram 100 of components interacting with a controller 110.

The controller 110 may include a control processor 112, an interface module 114, a monitor module 116, a registry module 118, and a user preference database 120. It will be understood that each of the modules in the controller 110 may be separately provided, or provided together as one or more hardware and/or software components. As shown in FIG. 1, the controller 110 may communicate, either directly or indirectly, with a designated master server 150 and one or more name server groups 140 (e.g., name server group 140a, name server group 140b, name server group 140c). One of the name server groups 140 may be an active name server group, and at least one of the other name server groups 140 may be a spare name server group.

It will be understood that each name server group 140 may include one or more name servers 142. For example, the name server group 140a includes three name servers 142a, 142b, and 142c. The one or more name servers 142 in each name server group 140 may be located in various geographical locations and associated within a network. The one or more name servers 142 in each name server group 140 may also be associated with different data centers and/or different network carriers. For example, the name servers 142 in each name server group 140 may be configured in an anycast constellation so that multiple physical name servers can respond to the same IP address.

The control processor 112 may be configured to initiate and/or manage the operations of each of the other modules in the controller 110. The control processor 112 may also determine, based on received data, stored data and/or user preferences, how the controller 110 may generally operate.

For example, the control processor 112 may be configured to initiate the registry module 118 to associate one of the name server groups 140 to the registry 130 of a domain name and to designate that name server group 140 as an active name server group. The control processor 112 may further be configured to initiate the registry module 118 to provide to the registry 130 at least one of the other name server groups 140 as spare name server groups. The control processor 112 may also be configured to initiate the monitor module 116 to implement or trigger a monitoring operation for receiving operation data associated with the name server groups 140. The control processor 112 may further collate and analyze the received operation data in order to determine whether an operation condition indicating degraded performance at the name server groups 140 is present. In some embodiments, the control processor 112 may be configured to determine the operation condition indicating degraded performance and may be further configured to modify a name server delegation of the domain name.

The interface module 114 may be a communication interface for receiving and/or transmitting data for the controller 110. For example, operation data corresponding to the name server groups 140 may be received via the interface module 114. The interface module 114 may, in some embodiments, provide a user interface for receiving information into the controller 110. For example, the controller 110 may receive user preference data via a preference user interface and the control processor 112 may then store the received user preference data into the user preference database 120. In a further example, the controller 110 may directly or indirectly communicate with one or more computing devices 170 via the interface module 114. The controller 110 may operate with the interface module 114 for communicating with the computing device 170 over a network. The computing device 170 may be a personal computer, laptop, personal data assistant, cellular telephone, smart-phone device, tablet computer, and/or wireless device.

The designated master server 150 may include one or more name servers or systems that, together, act as a master server for a domain name. The designated master server 150 may be managed by a domain name service provider or an owner of the domain name. As the master server, the resource records corresponding to the designated master server 150 may be considered the current resource records for the domain name.

Each of the name server groups 140 may include one or more name servers 142. Each name server group 140 may correspond to one or more DNS providers. These name server groups 140 may be provided to act as the active name server group for a domain name. However, in order to act as the active name server group for the domain name, the local resource records associated with the name servers 142 in each name server group 140 should, at least, be synchronized, or correspond, with the current resource records that are maintained by the designated master server 150. For ease of exposition, only three name server groups 140 are illustrated in FIG. 1. For the systems and methods described herein, it will be understood that two or more name server groups 140 may be provided.

The data transfer module 160 may provide transfer of resource record data from the designated master server 150 to the name server groups 140. The data transfer module 160 may be provided as a hardware component, such as a dedicated server, that is separate from the designated master server 150 and the name server groups 140. By providing the data transfer module 160 as a separate server or pools of servers, the controller 110 may be more easily integrated into existing domain name systems. Alternatively, the data transfer module 160 may be implemented as a hardware component and/or a software module as part of existing hardware components, such as physical servers. For example, the data transfer module 160 may be integrated as part of the designated master server 150.

It will generally be understood that resource record data may be transferred using different methods. For example, the resource record data may be transferred using the DNS Zone Transfer Protocol (AXFR) as described in RFC 1034 and RFC 5936, or the Incremental Zone Transfer Protocol (IXFR) as described in RFC 1995. Alternatively, the resource record data may be formatted and presented to a third-party name service. Also, the resource record data may be exported in a specified format (e.g., BIND, csv, SQL, XML, etc) and made available to be imported into another name server 142.

The control processor 112 may be configured to initiate the monitor module 116 to trigger a monitoring operation for receiving operation data associated with the name server groups 140. The monitoring operation may also include a determination of whether local resource records at the name server groups 140 correspond with the current resource records. In some embodiments, the monitoring operation may be triggered at regular time intervals or variable time intervals (e.g., depending on traffic loads or a different time period in a day). The monitoring operation may also be triggered in accordance with operation preferences associated with the domain names, service levels, or special events within the domain name system (e.g., a report of a problem at a name server group 140). In some embodiments, the monitoring operation may operate by continuously polling for operation data from the name server groups 140. In some embodiments, the monitoring operation may operate by receiving operation data from the name server groups 140.

In some embodiments, the monitoring operation may be conducted by one or more hardware and/or software components. For example, a physical server or a virtual private server that is separate from the controller 110 may conduct the monitoring operation. In another example, a hardware module or component and/or software module or program (e.g., daemons, processes, etc) provided in existing hardware components, such as physical servers, may conduct the monitoring operation.

In some embodiments, the monitoring operation may also be conducted at one or more monitors, such as monitoring nodes or points. These monitors may be located at different geographical locations and/or diverse network locations. For example, the monitors may be deployed within a monitoring cloud. Alternatively, the monitors may be deployed as a software module on each of the name server groups 140. Multiple monitors may be employed for obtaining a fuller depiction of an operation condition or status of the name server groups 140. For example, a monitor may indicate a failure operation but that failure operation may be due to an outage at that monitor due to a local network problem, instead of a problem with a name server 142 in the name server delegation for a domain name. Multiple monitors, therefore, may provide more comprehensive operation data regarding the name server groups 140.

The user preference database 120 may store information indicating how a user may prefer the controller 110 to operate. For example, the user preference database 120 may store data indicating specific thresholds and/or events that can cause the monitor module 116 to trigger the monitoring operation. The user preference database 120 may also store data indicating how the controller 110 may respond to a determination of an operation condition indicating degraded performance. For example, the user preference data may indicate operation conditions that may warrant revocation of one or more degraded name servers and operation conditions that may warrant replacing the active name server group with a spare name server group. In a further example, the user preference database 120 may store a threshold number of name server 142 for indicating how the name server delegation may be modified, that is, whether to revoke degraded name servers or to replace the active name server group. It will be understood that other similar user preference information may be stored in the user preference database 120. For example, the user preference information may indicate how the name server groups 140 may be prioritized (e.g., a priority may be assigned to each name server group 140), such as by a number of name servers 142 in a name server group 140, the types of name servers 142 in a name server group 140 and/or the geographical locations of name servers 142 in a name server group 140.

The control processor 112 may be configured to initiate the registry module 118 to communicate, either directly or indirectly, with the registry 130. The registry 130 may generally be a base registry for a top-level domain (e.g., the “.com” domain or the “.ca” domain). The registry module 118 may access the registry 130 for modifying the name server delegation of a domain name, such as to remove an individual name server 142 from the name server delegation or to reinstate a previously removed name server. In some embodiments, the registry module 118 may directly access the registry 130 of a domain name. In some embodiments, the registry module 118 may access the registry 130 of a domain name through an intermediary platform, such as with a third-party registry platform.

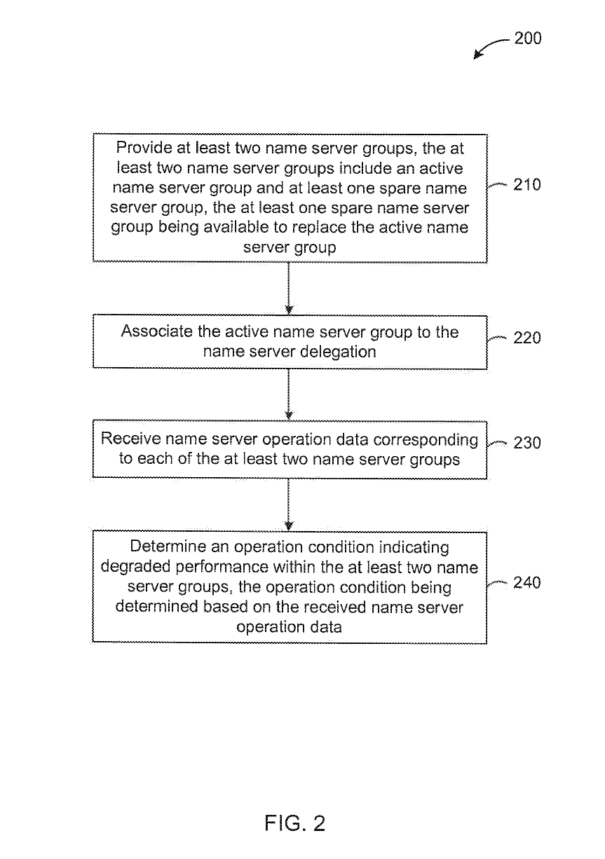

Referring now to FIG. 2, steps for maintaining domain name service for a domain name are shown in a flowchart diagram 200.

At step 210, the control processor 112 provides at least two name server groups 140.

As described above, the name server groups 140 include an active name server group that acts as the authoritative name server for the domain name and at least one spare name server group. The spare name server group may be available to replace the active name server group.

In some embodiments, the control processor 112 may be configured to provide the name server groups 140 to the registry 130 via the registry module 118. The registry module 118 may submit a request for the name server groups 140 to be included into the registry 130.

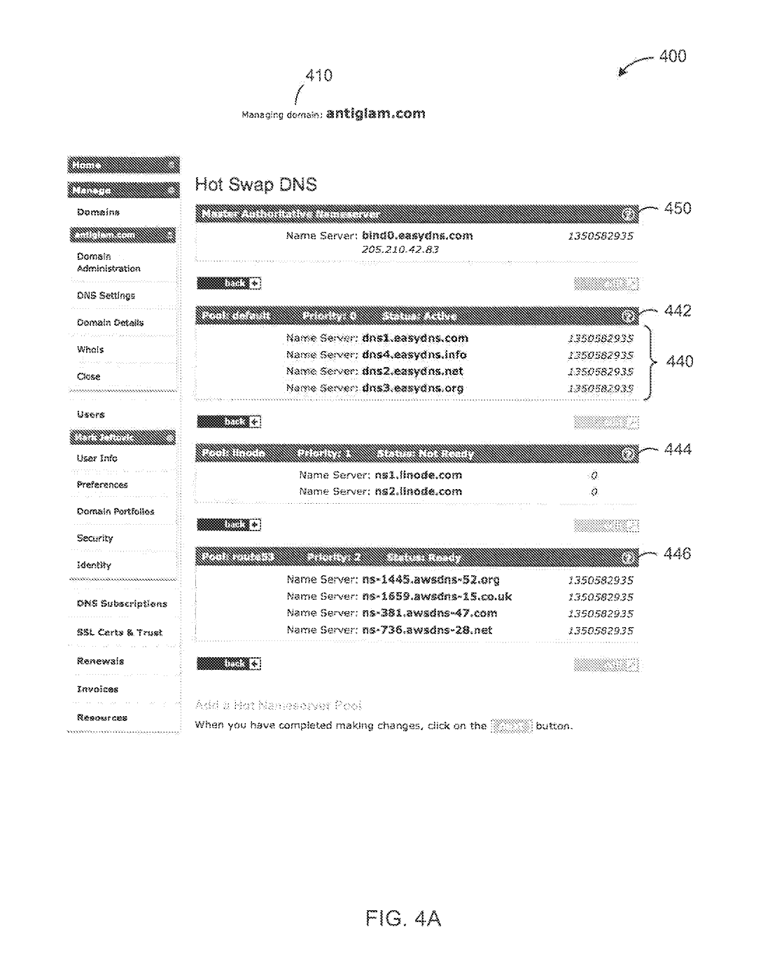

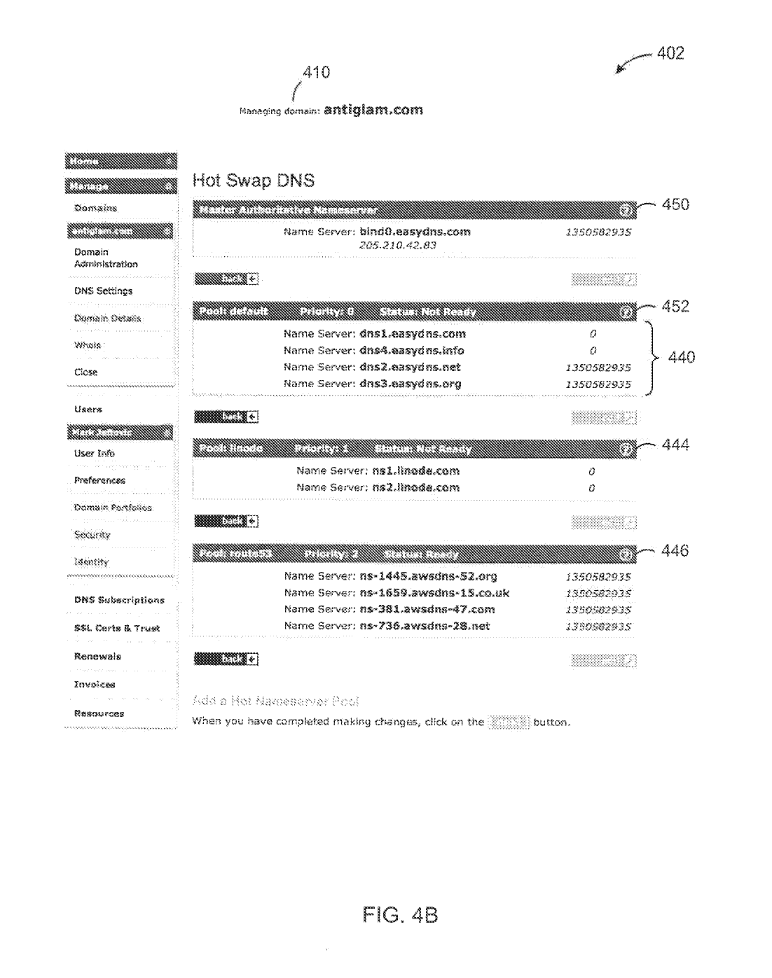

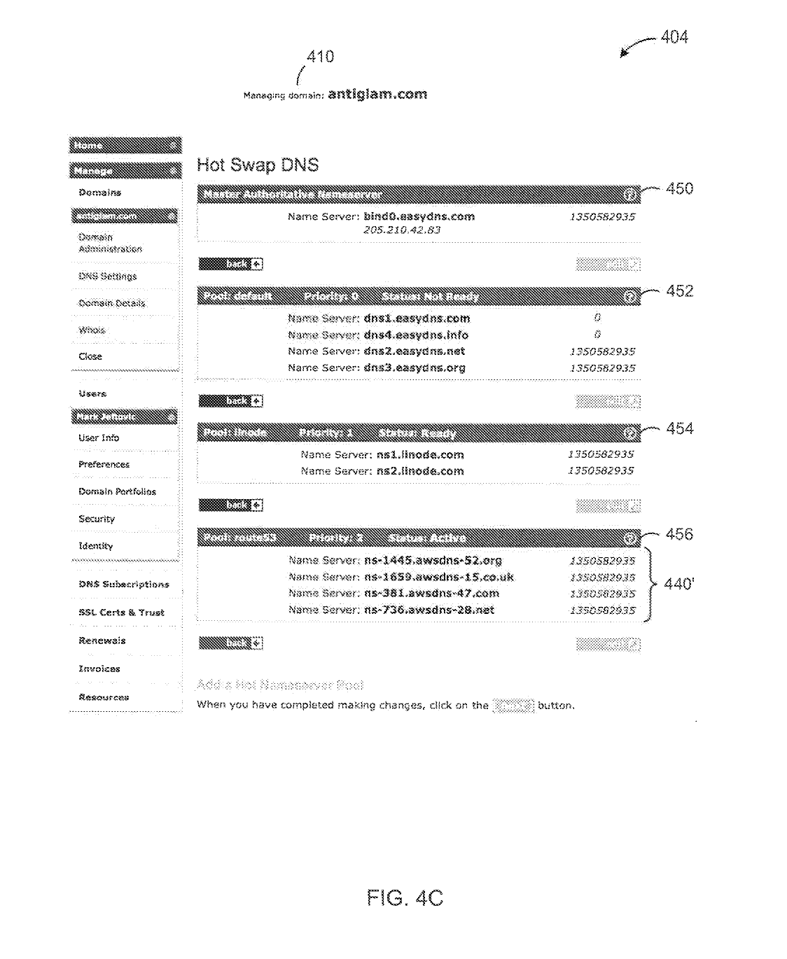

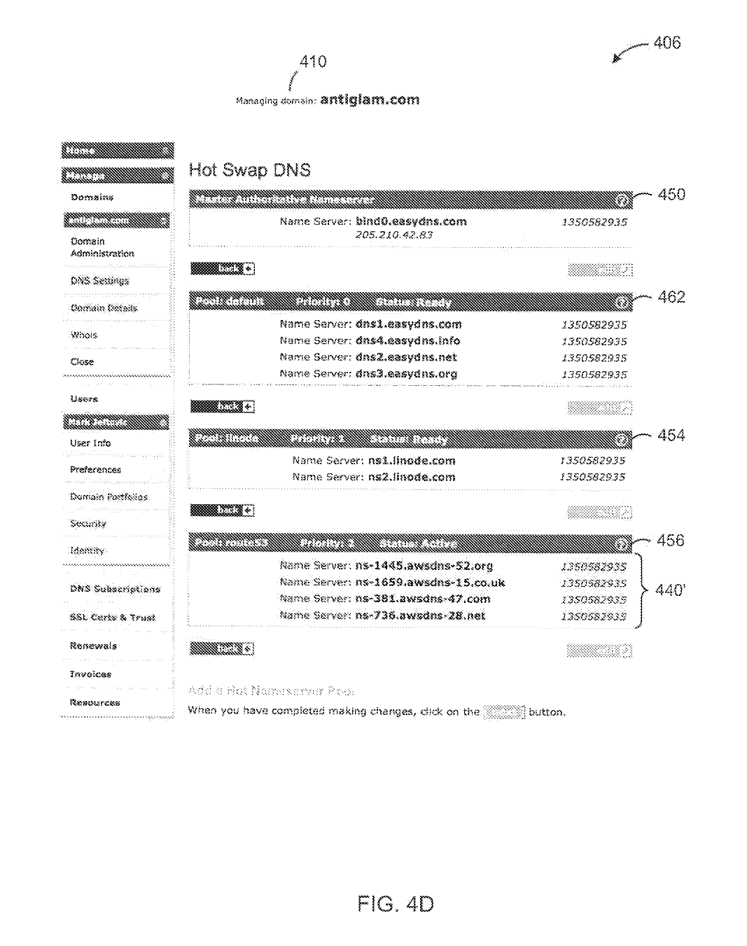

Referring briefly to FIG. 4A, a screenshot 400 of an example list of name servers for a domain name 410 is shown. As illustrated, the domain name 410 is “antiglam.com” and the designated master server 150 is provided as the name server 450, “bind0.easydns.com”. The name server groups 140 available to act as the active name server group for the domain name 410 include an active name server group 442 and two spare name server groups 444 and 446. Since the active name server group 442 is currently operating as the authoritative name server, the active name server group 442 is generally associated with the highest priority. The spare name server groups 444 and 446 are, therefore, associated with lower priorities.

At step 220, the control processor 112 associates the active name server group 442 to the name server delegation.

As illustrated in FIG. 4A, the name servers 142 within the active name server group 442 form a name server delegation 440.

In order for a name server 142 to operate as an authoritative name server for a domain name, the name server 142 needs, at least, to be associated with local resource record data that corresponds to the current resource record data. Generally, the data transfer module 160 operates to update the local resource record data associated with each name server 142 in the name server groups 140 to correspond with the current resource record data. The data transfer module 160 may initiate the update at regular time intervals, variable time intervals, in accordance with user preferences, and/or in response to different system or name server events.

At step 230, the control processor 112 receives name server operation data corresponding to each of the at least two name server groups 140.

As described above with reference to FIG. 1, the control processor 112 may be configured to initiate the monitor module 116 to conduct a monitoring operation for receiving operation data associated with the name server groups 140. In some embodiments, the operation data may then be received into the controller 110 via the interface module 114.

Generally, the operation data may include data indicating operation conditions of the name server groups 140. For example, the operation data may indicate whether the name server groups 140 are synchronized with the designated master server 150 and an operation condition of the name server groups 140. For example, the operation condition may indicate that the performance of the name server groups 140 has degraded. The degraded performance may be due to one or more degraded name servers, and the one or more degraded name servers may be in one or more name server groups 140. In another example, the operation condition may indicate at least one of the name server groups 140 is accessible to a network and may act as an active name server.

In some embodiments, the operation data may include data indicating one or more operating characteristics of the name servers 142 in each name server group 140, such as a length of time a name server 142 requires for responding to a domain name service query.

In some embodiments, the operation data may include characteristics of the name server group 140, such as a total number of name servers 142 in each name server group 140.

In some embodiments, the controller 110 may receive the name server operation data from one or more monitors. The monitor may receive, either directly or indirectly, the name server operation data from the name server groups 140. The operation data may further include characteristics of the monitor, such as a number of monitors that are associated with the monitoring operation and a number of these monitors that succeeded in completing the monitoring operation. In some embodiments, the monitors that succeed in completing the monitoring operation may include monitors that successfully received operation data corresponding to each name server group 140.

At step 240, the control processor 112 determines an operation condition indicating degraded performance within the at least two name server groups 140.

The control processor 112 may determine the operation condition based on the name server operation data received at step 230.

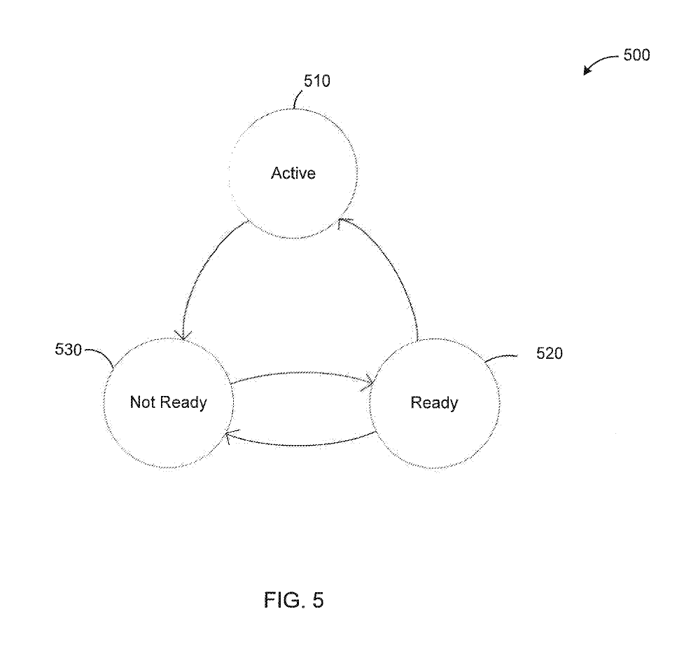

Referring now to FIG. 5, a state diagram 500 illustrating different operation conditions of a name server group 140 is shown.

As illustrated in FIG. 5, the operation condition for each name server group 140 may be selected from an active operation condition 510, a ready operation condition 520, and a “not ready” operation condition 530. A name server group 140 associated with the active operation condition 510 is the active name server group and therefore, is associated with the name server delegation.

The control processor 112 may associate a name server group 140 with the active operation condition 510. Accordingly, that name server group 140 would therefore act as the authoritative name server group for the domain name. As illustrated in FIG. 4A, the active name server group 442 is associated with an active status. In some embodiments, the control processor 112 may determine that a name server group 140, such as the active name server group 442, is “active” when all the name servers 142 within that name server group 140 are synchronized and not degraded. In some other embodiments, the control processor 112 may determine that a name server group 140 is active if that name server group 140 is functioning as the optimal name server group within the name server groups 140 provided in the registry 130 for that domain name 410.

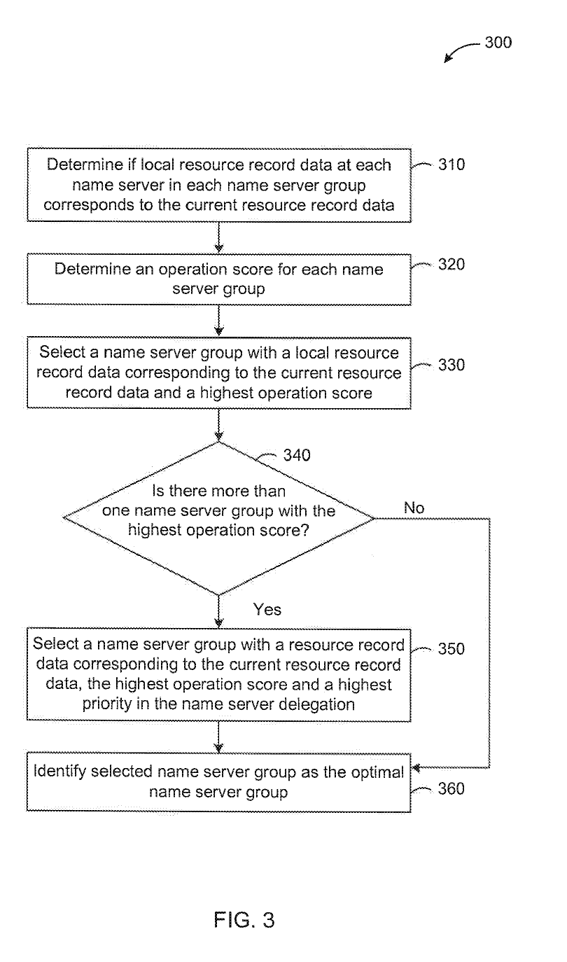

An identification of the optimal name server group is further described below with reference to FIG. 3. In some further embodiments, the control processor 112 may determine that a name server group 140 is active based on the received operation data and user preferences provided in the user preference database 120. For example, the control processor 112 may not associate the optimal name server group as active and may instead determine that a less optimal name server group is active due to user preference. The user preference may include preferences with respect to name server types, geographical locations of name servers 142 and other factors.

Referring still to FIG. 5, it is shown that a name server group 140 associated with the ready operation condition 520 may become associated with the active operation condition 510.

The control processor 112 may associate one or more name server groups 140 with the ready operation condition 520. Each such name server group 140 would therefore be available to be delegated as the authoritative name server group for the domain name. As illustrated in FIG. 4A, the spare name server group 446 is associated with the “Ready” status. In some embodiments, the control processor 112 may determine that a name server group 140, such as the spare name server group 446, is “ready” if all the name servers 142 within that name server group 140 are synchronized and not degraded. In some embodiments, the control processor 112 may determine a name server group 140 is ready based on the received operation data and user preferences provided in the user preference database 120. For example, the control processor 112 may determine that a name server group 140 is ready even if that name server group 140 includes one or more name servers 142 that may be degraded, but the name server group 140 meets operational thresholds associated with the domain name and/or user preferences. The operational thresholds may be stored in the user preference database 120.

Continuing to refer to FIG. 5, it is shown that a name server group 140 associated with the not ready operation condition 530 may become associated with the ready operation condition 520, and vice versa. As well, the active name server group may become a name server group 140 associated with the not ready operation condition 530.

The control processor 112 may associate one or more name server groups 140 with the not ready operation condition 530. That name server group 140 would therefore not be available to act as the authoritative name server group for the domain name. As illustrated in FIG. 4A, the spare name server group 444 is associated with the not ready status. In some embodiments, the control processor 112 may determine that a name server group 140, such as the spare name server group 444, is not ready if one or more name servers 142 within that name server group 140 is not synchronized or if the local network of that name server group 140 is unavailable or inaccessible. In some embodiments, the control processor 112 may determine a name server group 140 is not ready based on the received operation data and user preferences provided in the user preference database 120. For example, the control processor 112 may determine that a name server group 140 is not ready if the number of synchronized name servers in that name server group 140 fails to meet a minimum synchronized threshold that requires a minimum number of name servers 142 within a name server group 140 to be synchronized. The minimum synchronized threshold may be associated with the domain name or indicated by user preferences.

In some further embodiments, the control processor 112 may determine that a name server group 140 is not ready if one or more name servers 142 within that name server group 140 has degraded, or fails to operate at all, causing that name server group 140 to be degraded. In some embodiments, the control processor 112 may determine a name server group 140 has degraded based on the received operation data and user preferences provided in the user preference database 120. For example, the control processor 112 may determine that a name server group 140 is associated with the not ready operation condition 530 if the number of degraded or failed name servers in that name server group 140 exceeds a minimum operational threshold that requires a minimum number of name servers 142 within a name server group 140 to not be degraded. The minimum operational threshold may be associated with the domain name and/or user preferences.

Depending on the determined operation condition, the control processor 112 may, in some embodiments, be configured to modify the name server delegation of the domain name. For example, the control processor 112 may operate with the registry module 118 to communicate with the registry 130 for modifying the name server delegation. In some further embodiments, the Name Server (NS) resource records corresponding to the designated master server 150 may also be modified to correspond with the modified name server delegation at the registry 130. In some embodiments, the control processor 112 may be configured to notify a user responsible for the domain of degraded performance prior to modifying the name server delegation and/or of a potential for degraded performance. The control processor 112 may be further configured to provide that user with an option to trigger modification of the name server delegation. The option to trigger modification of the name server delegation may include providing the user with a selection of different modifications. The notification may be delivered to the user's computing device 170 via e-mail, SMS and/or other similar formats.

In some embodiments, if the control processor 112 determines an operation condition that indicates degraded performance within the name server groups 140, the control processor 112 may be configured to further identify at least one of the degraded name servers causing the degraded performance. The control processor 112 may be configured to remove the degraded name server from the name server delegation at the registry 130. In some further embodiments, the control processor 112 may be configured to remove degraded name servers from a name server group 140 if the removal of the degraded name servers does not cause the remaining number of name servers to fall below a minimum name server threshold. The minimum name server threshold may indicate a minimum number of operational name servers that are required to be in a name server group 140. The minimum name server threshold may be stored in the user preference database 120.

In some embodiments, the control processor 112 may be configured to replace any removed degraded name servers with an operational name server. The operational name server may be associated with one of the name server groups 140.

In some embodiments, the control processor 112 may return any removed name servers to the name server delegation. For example, the controller 110 may receive a notification that indicates the removed name server has resumed its normal operations. That is, the removed name server may be operating in accordance with its typical operating characteristics. The control processor 112 may operate with the registry module 118 to associate the removed name server back to the name server delegation.

In some embodiments, the control processor 112 may modify the name server delegation at the registry 130 by replacing the active name server group with the optimal name server group. The control processor 112 may replace the active name server group 442 when the control processor 112 determines that all the name servers 142 in the active name server group 442 are degraded or failed. Alternatively, even if only several name servers 142 in the active name server group 442 are determined to be degraded, the control processor 112 may replace the active name server group 442 if the removal of the degraded name servers does not cause the remaining number of name servers to fall below the minimum name server threshold.

Referring now to FIG. 3, steps for selecting an optimal name server group are shown in a flowchart diagram 300. As described above with reference to FIG. 2, the control processor 112 may, in some embodiments, identify the active name server group 442 by selecting the optimal name server group.

At step 310, the control processor 112 determines if local resource record data at each name server 142 in each name server group 140 corresponds to the current resource record data.

Based on the received operation data, the control processor 112 may determine, for each name server 142 in each of the name server groups 140, if the local resource record data corresponds to the current resource record data.

In some embodiments, the control processor 112 may be configured to determine if the name servers 142 in each name server group 140 is synchronized by considering if the Start of Authority (SOA) value in each local resource record corresponds to the SOA value in the current resource record.

In some other embodiments, the control processor 112 may be configured to determine if the name servers 142 in each name server group 140 is synchronized by conducting a hostwalk of domain name service entries in the local resource record and the current resource record. It will be understood that the hostwalk may involve using resource records within a domain and querying each of those resource records at each name server 142 in the name server groups 140 and the designated master server 150. The control processor 112 may then compare the results from the queries to determine if the name servers 142 are synchronized. It will be further understood that certain values may be excluded from this comparison. Certain values may be excluded because the name servers 142 in the name server groups 140 may be synchronized even though certain values in the local resource record are different from those in the current resource record. The values that may be excluded from the comparison may include SOA resource records, NS resource records, and/or individual resource record Time-to-Live (TTL) values.

In some embodiments, the control processor 112 may determine that the name server group 140 is synchronized with the designated master server 150 when all the local resource record data of the name servers 142 in that name server group 140 correspond with the current resource record data.

In some embodiments, the control processor 112 may determine that the name server group 140 is synchronized with the designated master server 150 when the number of synchronized name servers in that name server group 140 does not fall below the minimum synchronized threshold. For example, the control processor 112 may determine that a name server group 140 is synchronized if at least three of the name servers 142 in that name server group 140 are synchronized. It will be understood that other appropriate threshold values may be applied.

At step 320, the control processor 112 determines an operation score for each name server group 140.

The operation score may correspond to one or more operation characteristics of the name server group 140. For example, the operation characteristics may include an indication of whether a name server 142 has degraded and a length of time the name server 142 requires for responding to a domain name service query. The operation characteristics may also include a cost associated with using a particular name server 142, a number of name servers within a name server group, and a geographical location of a name server 142.

In some embodiments, the control processor 112 may determine the operation score based on the length of time a name server 142 requires to respond to a query request. The control processor 112 may associate the highest operation score to a shortest response time.

In some embodiments, the control processor 112 may determine the operation score based on operation data received from one or more monitors. The operation characteristics may include characteristics of the monitor. For example, the operation score of a name server group 140 may correspond to a number of available name servers in the name server group 140 and an operational monitor value. The operational monitor value may correspond with the number of monitors that successfully receive the name server operation data from the name server groups 140.

In some further embodiments, the control processor 112 may generate the operation score for the name server group 140 using a ratio based on the number of operational name servers and a total number of name servers 142 in that name server group 140, and the operational monitor value. For example, the control processor 112 may apply the following algorithm for determining the operation score for a name server group 140:

(A/B)×C

where “A” represents the number of operational name servers in a name server group 140, “B” represents the total number of name servers 142 in that name server group 140, and “C” represents the operational monitor value of that name server group 140.

When the above algorithm is applied for identifying the optimal name server group, the control processor 112 may associate the highest numerical result as the highest operation score.

It will be understood that other algorithms may be used for determining the optimal name server.

At step 330, the control processor 112 selects a name server group 140 with a local resource record data corresponding to the current resource record data and a highest operation score.

Based on the results from step 310 and step 320, the control processor 112 may identify a name server group 140 that is synchronized with the designated master server 150 and that is associated with the highest operation score as the optimal name server group.

At step 340, the control processor 112 determines if there is more than one name server group 140 with the highest operation score.

In some embodiments, the control processor 112 may determine if there are multiple name server groups 140 that are both synchronized and associated with the highest operation score. If the control processor 112 determines there is more than one name server group 140 that is synchronized and associated with the highest operation score, the control processor 112 may be configured to perform step 350. However, if there is only one name server group 140 with the highest operation score, the control processor 112 may be configured to perform step 360.

At step 350, the control processor 112 selects a name server group 140 with a resource record data corresponding to the current resource record data, the highest operation score and a highest priority in the name server delegation.

When the control processor 112 determines there is more than one name server group 140 that is both synchronized and associated with the highest operation score, the control processor 112 may further determine which of these name server groups 140 has the highest priority. The control processor 112 may therefore identify the name server group 140 having a local resource record data corresponding to the current resource record data in the designated master server 150, the highest operation score and the highest priority as the optimal name server group.

At step 360, the control processor 112 identifies selected name server group as the optimal name server group.

Accordingly, the control processor 112 may then select the name server group 140 as selected from either step 340 or step 350 as the optimal name server group

Referring now to FIGS. 4A to 4D, screenshots of example lists of name servers for a domain name 410 are shown.

As described above with reference to FIG. 4A, the active name server group 442 is associated with the active operation condition 510 and therefore is associated with the name server delegation 440 for the domain name 410. The spare name server group 444 is associated with the not ready operation condition 530 since, as shown in FIG. 4A, the name servers 142 in the spare name server group 444 are not synchronized with the designated master server 450. The spare name server group 446 is associated with the ready operation condition 520, which indicates that it is available to act as an active name server group.

Referring now to FIG. 4B, a screenshot 402 of an example list of name servers for the domain name 410 is illustrated. The control processor 112 determines that the active operation condition 510 of the active name server group 442 of FIG. 4A has degraded. Accordingly, the active name server group 442 is now associated with the not ready operation condition 530, and may be referred to as a degraded name server group 452. As described above, the degraded name server group 452 may include one or more name servers 142 that have degraded or fail to operate.

Referring now to FIG. 4C, a screenshot 404 of an example list of name servers for the domain name 410 is illustrated. The control processor 112 has modified the name server delegation 440 to generate a modified name server delegation 440′ by replacing the degraded name server group 452 with the spare name server group 446 of FIGS. 4A and 4B. Accordingly, the spare name server group 446 is now a new active name server group 456 for the domain name 410. That is, the modified name server delegation 440′ is now associated with the name servers 142 of the new active name server group 456. The control processor 112 has also determined that the spare name server group 444 of FIGS. 4A and 4B is now synchronized and thus, the spare name server group 444 is now a name server group 454 associated with the ready operation condition 520.

Referring now to FIG. 4D, a screenshot 406 of an example list of name servers for the domain name 410 is illustrated. As shown in FIG. 4D, the control processor 112 has determined, or received the notification indicating, that the degraded name server group 452 of FIG. 40 has resumed normal operations and is now a name server group 462 associated with the ready operation condition 520. In another example, after the control processor 112 determines that the name server group 462 is available to act as an active name server group, the control processor 112 may proceed to replace the new active name server group 456 with the name server group 462 since the name server group 462 has a higher priority than the new active name server group 456.

The present invention has been described here by way of example only. Various modification and variations may be made to these exemplary embodiments without departing from the spirit and scope of the invention, which is limited only by the appended claims.

We claim:

1. A method for maintaining domain name service for a domain name, the domain name being associated with current resource record data and a name server delegation, the method comprising:
providing at least two name server groups, the at least two name server groups comprising an active name server group and at least one spare name server group, the at least one spare name server group being available to replace the active name server group;
associating the active name server group to the name server delegation;
receiving name server operation data corresponding to each of the at least two name server groups; and
determining an operation condition indicating degraded performance within the at least two name server groups, the operation condition being determined based on the received name server operation data.

2. The method of claim 1,
wherein the step of determining an operation condition further comprises identifying one of the at least two name server groups as an optimal name server group; and
subsequent to identifying the optimal name server group, modifying the name server delegation by replacing the active name server group with the optimal name server group.

3. The method of claim 2, wherein the step of identifying one of the at least two name server groups as an optimal name server group further comprises:
determining, for each name server in each of the at least two name server groups, if a local resource record data corresponding to a name server corresponds to the current resource record data;
determining an operation score for each of the at least two name server groups, the operation score corresponding to at least one operation characteristic of a name server group; and
selecting, from the at least two name server groups, a name server group having (a) a local resource record data corresponding to the current resource record data and (b) a highest operation score.

4. The method of claim 3, wherein the step of selecting a name server group further comprises:
determining, from the at least two name server groups, a number of name server groups associated with the highest operation score; and
subsequent to determining the number of name server groups associated with the highest operation score is more than one, selecting, from the at least two name server groups, a name server group having (a) a local resource record data corresponding to the current resource record data, (b) the highest operation score and (c) a highest priority.

5. The method of claim 3, wherein
the name server operation data is received from at least one monitor, the at least one monitor receives the name server operation data from the at least two name server groups;
the step of determining an operation score for each of the at least two name server groups further comprises determining an operational monitor value, the operational monitor value being a number of the at least one monitor successfully receiving the name server operation data from the at least two name server groups; and
the operation score for a name server group corresponds to a number of operational name servers in the name server group and the operational monitor value.

6. The method of claim 5, wherein the step of determining an operation score for each of the at least two name server groups further comprises:
for each of the at least two name server groups, determining a ratio based on the number of operational name servers and a total number of name servers; and
generating the operation score based on the ratio and the operational monitor value.

7. The method of claim 3, wherein the at least one operation characteristic of a name server group comprises a response time to a query request and the highest operation score corresponds to a shortest response time.

8. The method of claim 1 further comprises:
subsequent to determining the operation condition, identifying at least one degraded name server causing the degraded performance within the at least two name server groups; and
removing the at least one degraded name server from the name server delegation.

9. The method of claim 8 further comprises:
replacing each of the removed at least one degraded name server with an operational name server.

10. The method of claim 8 further comprises:
receiving a notification indicating the removed at least one degraded name server has resumed normal operations; and
subsequent to receiving the notification, associating the removed at least one degraded name server to the name server delegation.

11. A system for maintaining domain name service for a domain name, the domain name being associated with current resource record data and a name server delegation, the system comprising a control processor, wherein the control processor is configured to:
provide at least two name server groups, the at least two name server groups comprising an active name server group and at least one spare name server group, the at least one spare name server group being available to replace the active name server group;
associate the active name server group to the name server delegation;
receive name server operation data corresponding to each of the at least two name server groups; and
determine an operation condition indicating degraded performance within the at least two name server groups, the operation condition being determined based on the received name server operation data.

12. The system of claim 11, wherein the control processor is further configured to:
identify one of the at least two name server groups as an optimal name server group; and
modify, subsequent to identifying the optimal name server group, the name server delegation by replacing the active name server group with the optimal name server group.

13. The system of claim 12, wherein the control processor is further configured to:
determine, for each name server in each of the at least two name server groups, if a local resource record data corresponding to a name server corresponds to the current resource record data;
determine an operation score for each of the at least two name server groups, the operation score corresponding to at least one operation characteristic of a name server group; and
select, from the at least two name server groups, a name server group having (a) a local resource record data corresponding to the current resource record data and (b) a highest operation score.

14. The system of claim 13, wherein the control processor is further configured to:
determine, from the at least two name server groups, a number of name server groups associated with the highest operation score; and
select, subsequent to determining the number of name server groups associated with the highest operation score is more than one, a name server group from the at least two name server groups, the name server group having (a) a local resource record data corresponding to the current resource record data, (b) the highest operation score and (c) a highest priority.

15. The system of claim 13, wherein
the name server operation data is received from at least one monitor, the at least one monitor receives the name server operation data from the at least two name server groups;
the control processor is further configured to determine an operational monitor value, the operational monitor value being a number of the at least one monitor successfully receiving the name server operation data from the at least two name server groups; and
the operation score for a name server group corresponds to a number of operational name servers in the name server group and the operational monitor value.

16. The system of claim 15, wherein the control processor is further configured to:
determine, for each of the at least two name server groups, a ratio based on the number of operational name servers and a total number of name servers; and
generate the operation score based on the ratio and the operational monitor value.

17. The system of claim 13, wherein the at least one operation characteristic of a name server group comprises a response time to a query request and the highest operation score corresponds to a shortest response time.

18. The system of claim 11, wherein the control processor is further configured to:
identify, subsequent to determining the operation condition, at least one degraded name server causing the degraded performance within the at least two name server groups; and
remove the at least one degraded name server from the name server delegation.

19. The system of claim 18, wherein the control processor is further configured to:
replace each of the removed at least one degraded name server with an operational name server.

20. The system of claim 18, wherein the control processor is further configured to:
receive a notification indicating the removed at least one degraded name server has resumed normal operations; and
associate, subsequent to receiving the notification, the removed at least one degraded name server to the name server delegation.

21. A non-transitory computer-readable medium comprising instructions executable on a control processor for implementing a method for maintaining domain name service for a domain name, the domain name being associated with current resource record data and a name server delegation, the method comprising:
providing at least two name server groups, the at least two name server groups comprising an active name server group and at least one spare name server group, the at least one spare name server group being available to replace the active name server group;
associating the active name server group to the name server delegation;
receiving name server operation data corresponding to each of the at least two name server groups; and
determining an operation condition indicating degraded performance within the at least two name server groups, the operation condition being determined based on the received name server operation data.
